(19) United States
(12) Patent Application Publication
(10) Pub. No.: US 2024/0408757 A1
(43) Pub. Date: Dec. 12, 2024

(54) HUMAN-IN-LOOP ROBOT TRAINING AND TESTING SYSTEM WITH GENERATIVE ARTIFICIAL INTELLIGENCE (AI)

(71) Applicant: ACUMINO, Renton, WA (US)

(72) Inventors: Patrick McKinley JARVIS, Redmond, WA (US); Ke WANG, Charlottesville, VA (US); Minas LIAROKAPIS, Lynfield (NZ)

(21) Appl. No.: 18/738,598

(22) Filed: Jun. 10, 2024

Related U.S. Application Data
(60) Provisional application No. 63/472,144, filed on Jun. 9, 2023.
(60) Provisional application No. 63/583,733, filed on Sep. 19, 2023.
(60) Provisional application No. 63/598,292, filed on Nov. 13, 2023.

(51) Int. Cl. B25J 9/16; B25J 13/00

(52) U.S. Cl. CPC B25J 9/1671; B25J 9/1661; B25J 9/1664; B25J 13/00

(57) ABSTRACT

A robot teaching and testing system and method that performs human-operated robot tasks according to instructions generated from generative AI models. The process starts with a user prompt and combines the user prompt with predefined prompt templates to generate well-formatted text prompts. Generative AI models take the text prompts and convert them into high-level instructions or control codes that can be deployed on a robot. The high-level instructions are then converted into human-operated robot tasks for a human data collector using a mixed reality (MR) device. The human data collector will attempt to follow the instructions to complete the human-operated robot tasks and may overwrite the suggested instructions by performing a different action, demonstrate a task without instructions, or leave feedback or comments regarding the tasks. Feedback data will be captured and saved for improving the robot system.

### CROSS-REFERENCE TO RELATED APPLICATIONS

This application claims the benefit of and priority to U.S. Provisional Patent Application No. 63/472,144, filed on Jun. 9, 2023, U.S. Provisional Patent Application No. 63/583,733, filed on Sep. 19, 2023, and U.S. Provisional Patent Application No. 63/598,292, filed on Nov. 13, 2023, which are each incorporated herein by reference in their entirety.

### FIELD OF THE DISCLOSURE

The disclosure relates to human-in-loop robot training and testing with generative artificial intelligence (AI).

### BACKGROUND

In order to control robots in performing various robot control tasks, it is often necessary to train one or more machine learning models and other software that are used in a robot control system. However, it can be difficult to obtain sufficient data in an easy, scalable, and cost-efficient manner to train the machine learning models and other software.

Generative Artificial Intelligence (AI) models including, but not limited to, large language models (LLM) and large vision models have shown potential in methods for creating instructions such as software programs that control a robot. However, the execution of the high-level instructions generated by an LLM relies heavily on low-level libraries, such as computer vision libraries, motion planning libraries, and motion execution libraries. If one of the low-level libraries is not capable of a task, the whole program will fail.

For example, if a low-level computer vision library was not trained to detect avocados, the mission to pick up an avocado and put it into a bowl would fail. Further, under this AI model framework for generating robot instructions, there is no clear way to improve the performance of a robot. User tuning of a prompt for the AI model does not affect the performance of the low-level libraries.

It is likewise a challenge in the generation of robot instructions using AI models to detect the cause of any failures, especially for a complicated robot action with multiple steps. Usually, the user has to monitor the whole execution process, or parse the log files and identify the cause of failure. The user can only detect one cause at a time, and the execution may fail in multiple steps, resulting in an ineffective, time-consuming, and expensive process.

Accordingly, there exists a need in the art to provide systems and methods that allow for the training and/or testing of machine learning models and other software that are used in robot control systems in an easy, fast, and cost-efficient manner.

Embodiments disclosed herein introduce a human-in-the-loop method to solve these issues. Instead of deploying the high-level instructions generated from LLM on a robot, the innovation disclosed herein provides a framework where the data of human behavior in the real world will be collected for improving the robot system. The proposed method first converts the high-level instructions into human-operated robot tasks, generates instructions for each task, and deploys the instructions onto a Mixed-Reality (MR) based instruction-feedback system. A human data collector follows the instructions and executes the tasks using a human-machine operation interface. The causes of the failure could be identified directly during this process. The data on human behavior and human feedback will be stored for further improving the low-level libraries/algorithms if the causes of failure are identified in corresponding libraries/algorithms.

### SUMMARY

Embodiments disclosed herein are related to a robot teaching and testing system that performs human-operated robot tasks according to instructions generated from generative AI models. The process starts with a user prompt, such as a text prompt, a graphic prompt (e.g., a graph or a picture), a voice prompt, or the like. The teaching and testing system combines the user prompt with predefined prompt templates to generate well-formatted text prompts. Generative AI models take the text prompts and convert them into high-level instructions or control codes that can be deployed on a robot. The high-level instructions are then converted into human-operated robot tasks.

The human-operated robot tasks are transmitted to a teaching-feedback system, where a human data collector may watch visual instructions in text or virtual marker format using a mixed reality (MR) device and/or listen to audio instructions from sound devices that specify how to execute the human-operated robot tasks. The human data collector will attempt to follow the instructions to complete the human-operated robot tasks one by one. In this process, the human data collector may overwrite the suggested instructions by performing a different action, demonstrate a task without instructions, or leave feedback or comments regarding the tasks. Feedback data will be captured and saved for improving the robot system.

In one embodiment, a system for testing and/or training a robot control system includes at least the following elements: 1) visual sensing devices, 2) an MR device, 3) a data collection device, 4) a computation device including a machine learning model or other software that is to be tested and/or trained, and 5) a storage device that records sensing and controlling data that is collected during the testing and/or training.

In some embodiments, the visual sensing devices may include multiple cameras, such as depth cameras, which are located on the data collection device, bird-view cameras and/or depth cameras, which are located on a wall or ceiling of a testing and/or training location, and other cameras and types of visual sensors as needed. The various cameras may be configured to detect a pose of a person performing the testing and/or training, a pose of the data collection device such as a human-machine interface, and other end effectors such as hands or gloves, and/or an object being manipulated by the data collection device.

In some embodiments, the MR device is a platform that allows a human data collector to communicate with the various other elements of the testing and/or training system. The human data collector also receives and visualizes via the MR device instructions and feedback from the computation device that direct the human data collector to perform various human-operated robot tasks related to testing and/or training the machine learning model.

In some embodiments, the data collection device may comprise a human-machine operation interface worn by the human data collector and used to perform the various human-operated robot tasks related to testing and/or training the machine learning model or other software. The data collection device may include various cameras and sensors that are configured to collect data related to the performed human-operated robot tasks.

In some embodiments, the data collection device may comprise a forearm-mounted human-machine operation interface that is used to operate one or more robotic grippers or robotic hands in the execution of complex grasping and manipulation human-operated robot tasks. In other embodiments, the data collection device may comprise a palm-mounted human-machine operation interface that is used to operate one or more robotic grippers or robotic hands in the execution of complex grasping and manipulation human-operated robot tasks.

In still other embodiments, the hands and/or arms of the human data collector may be considered as the data collection device. In such embodiments, visual sensing devices that are mounted on the wall or the ceiling of the testing and/or training location can track the hands and/or arms of the human data collector in the execution of the grasping and manipulation human-operated robot tasks. In further embodiments, the data collection device may comprise sensing gloves or hand pose tracking devices, such as motion capture gloves. In still further embodiments, the data collection device may comprise any combination of a human-machine operation interface, the human data collector hands and/or arms, the sensing gloves, or the hand pose tracking devices.

In some embodiments, the computation device oversees real-time synchronization of multiple data resources, data processing, and data visualization by providing commands to and receiving collected data from the other elements of the testing and/or training system. As mentioned, the computation device may include the machine learning model and other software that is being trained and/or tested. In some embodiments, the computation device includes processing capabilities that allow it to execute the machine learning model and the other software so that the machine learning model and other software can be trained and/or tested.

The storage device includes storage capabilities so that the data collected from the other elements of the testing and/or training system can be stored and then used to train and/or test the robot control system.

These and other features, aspects, and advantages of the present disclosure will become better understood through the following description, appended claims, and accompanying drawings.

### BRIEF DESCRIPTION OF THE DRAWINGS

FIG. 1 illustrates a diagram of a user-on-the-loop method to applying generative AI models in robotic applications.

FIG. 2 compares a user-on-the-loop method with a human-in-the-loop method according to embodiments of the current disclosure and shows how a human-in-the-loop method can be used to improve performance of robots according to embodiment disclosed herein.

FIG. 3 illustrates a structure of a system for implementing a human-in-the-loop method according to embodiments disclosed herein.

FIG. 4 illustrates a diagram of a proposed workflow of a human-in-the-loop method in robotic applications according to embodiments disclosed herein.

FIG. 5 shows an example of a prompt according to embodiments disclosed herein.

FIG. 6 shows an example of high-level instructions or codes generated from a generative AI model according to embodiments disclosed herein.

FIG. 7 shows an example of a list of human-operated robot tasks converted from high-level instructions or codes according to embodiments disclosed herein.

FIG. 8 shows an example of a list of human-operated robot tasks displayed in an MR device according to embodiments disclosed herein.

FIG. 9 shows an example of human-in-the-loop task execution.

FIG. 10 shows an example of a virtual marker displayed in an MR device which indicates an object of interest.

FIG. 11 shows an example of a virtual marker displayed in an MR device which indicates a location and a path toward this location.

FIG. 12 illustrates a diagram of a human-in-the-loop method to applying generative AI models in robotic applications.

The drawing figures are not necessarily drawn to scale. Instead, they are drawn to provide a better understanding of the components thereof, and are not intended to be limiting in scope, but to provide exemplary illustrations.

### DETAILED DESCRIPTION OF VARIOUS EMBODIMENTS

A better understanding of the disclosure's different embodiments may be had from the following description read with the drawings in which like reference characters refer to like elements. While the disclosure is susceptible to various modifications and alternative constructions, certain illustrative embodiments are shown in the drawings and are described below. It should be understood, however, there is no intention to limit the disclosure to the specific embodiments disclosed, but on the contrary, the aim is to cover all modifications, alternative constructions, combinations, and equivalents falling within the spirit and scope of the disclosure.

The references used are provided merely for convenience and hence do not define the sphere of protection or the embodiments. It will be understood that unless a term is expressly defined in this application to possess a described meaning, there is no intent to limit the meaning of such term, either expressly or indirectly, beyond its plain or ordinary meaning. Any element in a claim that does not explicitly state “means for” performing a specified function or “step for” performing a specific function is not to be interpreted as a “means” or “step” clause as specified in 35 U.S.C. § 112.

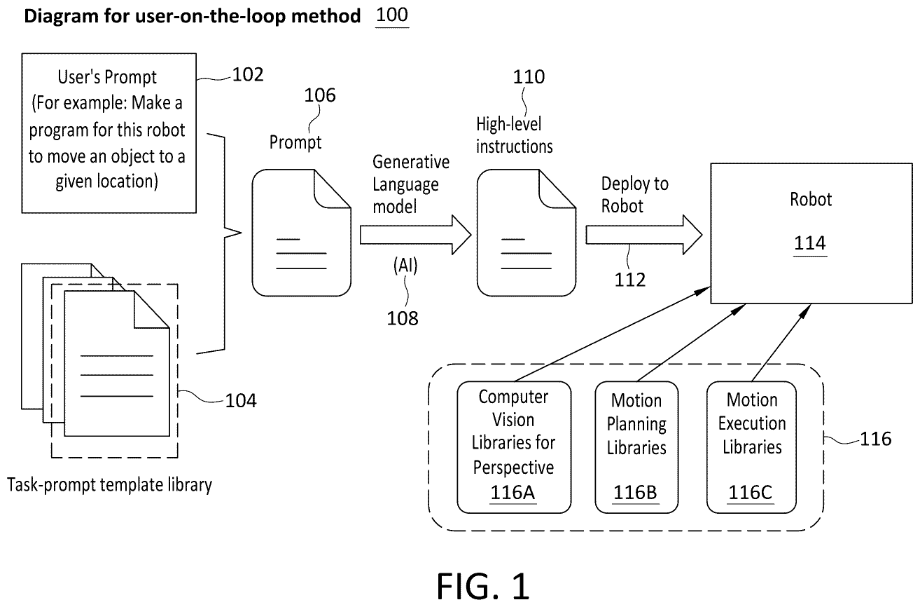

FIG. 1 illustrates a user-on-the-loop method 100 to applying generative AI to robotics applications such as applications for deploying the robot to perform one or more tasks. This user-on-the-loop method first combines a user's prompt 102 with a pre-defined task-prompt template library 104 and generates an appropriate prompt 106 to feed into a generative AI model 108 such as ChatGPT.

The user prompt 102 is input, usually text or voice, that instructs the generative AI model 108 to generate a response. In the depicted method of FIG. 1, the user's prompt 102 instructs the generative AI model 108 to make a program that, when executed on a target robot 114, will cause the robot 114 to move an object from one location to another. The task-prompt template library 104 includes various templates that can be used to help make the program. For example, a template for moving a specific object may include information such as movement in an XYZ plane that can be used in the program.

Prompt 106 which results from applying one or more of the templates of the task-prompt template library 104 to user's prompt 102 instructs the generative AI model 108 to create the program that will be deployed onto the target robot 114 to move the object. The generative AI model 108 then creates high-level instructions 110, for example comprising high-level control codes or high-level executable codes such as Python code, which focuses on logic instead of execution. Thus, the high-level instructions focus on the overall process the robot performs and the low-level libraries focus on the individual steps of the overall process.

The high-level instructions 110 may then be deployed 112 on the target robot 114 to trigger, when executed, the robot 114 so as to perform one or more tasks defined by generative AI model 108, which in the illustrated method is to grasp and move the object. During the task execution, the high-level instructions 110 may call predefined low-level libraries 116, such as computer vision libraries 116A, motion planning libraries 116B, and motion execution libraries 116C to be used to cause, when executed, the target robot 114 to move the object.

There are problems associated with the illustrated user-on-the-loop method. First, the user-on-the-loop method does not provide a path to improve the method. Further, it is difficult to identify the cause of the failure, especially where, in some scenarios, multiple steps of a task may fail. The user-on-the-loop method can only identify one failure step at a time. The user is likewise limited to changing the prompt as a way to correct any failures. In most cases, the user can only guess the cause of the failure and must use this guess to try to modify any prompts that are fed into the generative AI model. Without improving the AI models and algorithms, the user-on-the-loop method may not work.

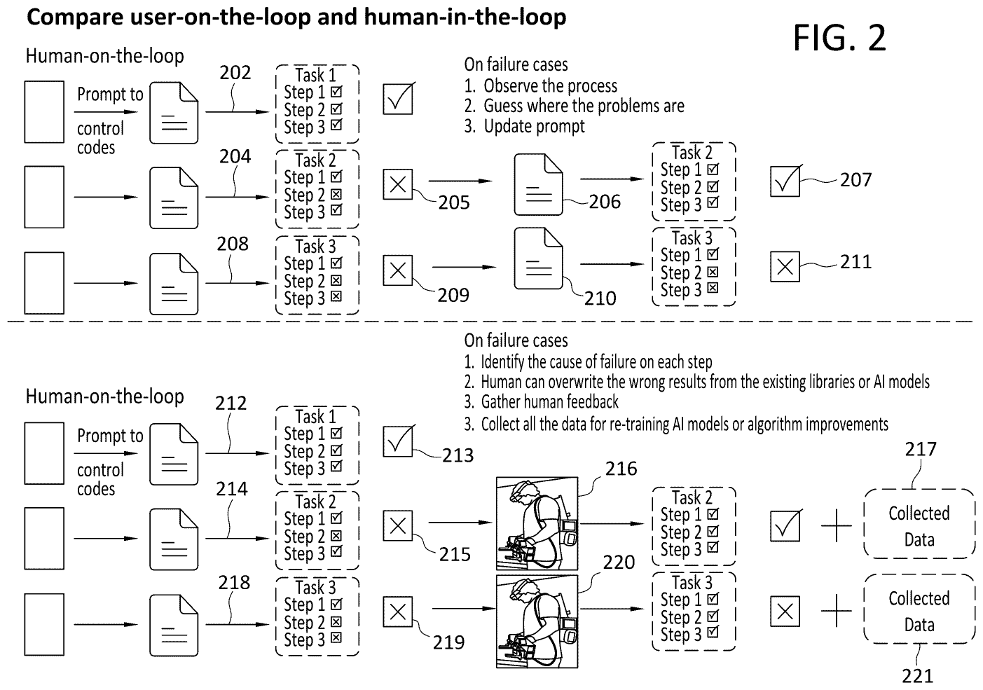

FIG. 2 illustrates applying the described user-on-the-loop method to a real-world robotics application. In each application, a prompt 106 is fed to the generative language model 108 to generate high-level instructions or control codes that when executed cause the target robot 114 to perform various tasks. In application 202, the target robot 114 is able to perform all three steps as evidenced by the check-mark 203.

However, in application 204, the target robot fails to perform step 2 as evidenced by “X” 205. In such a case, a user has no easy way of identifying what caused the failure of step 2. All the user can do is observe the process, note the failure, guess what caused the failure, and then generate an updated prompt 206 based on that guess that attempts to cause the generative AI model 108 to generate high-level instructions or control codes that when executed cause the target robot 114 to correctly perform step 2. As mentioned, the cause of the failure is a guess, leading to inaccuracy and inefficiency in addressing the failure.

In contrast, a human-in-the-loop method according to embodiments disclosed herein converts the high-level instructions into human-operated robot tasks and deploys them onto a teaching-testing system. A human data collector wears robotic devices and completes the tasks according to the instructions provided by the teaching-testing system. In failure cases, the human data collector knows which steps and which instructions cause the failure in real-time. As such, the human data collector can overwrite the wrong instructions, leave feedback or notes, and move forward without restarting the entire test or training.

Further, a human-in-the-loop method according to the disclosed embodiments enables the human data collector to identify multiple failure causes at different steps. Likewise, for some novel actions that the trained AI models and algorithms are not capable of implementing, the human data collector can simply demonstrate the action, such that the data is collected to train the AI models or improve the algorithms.

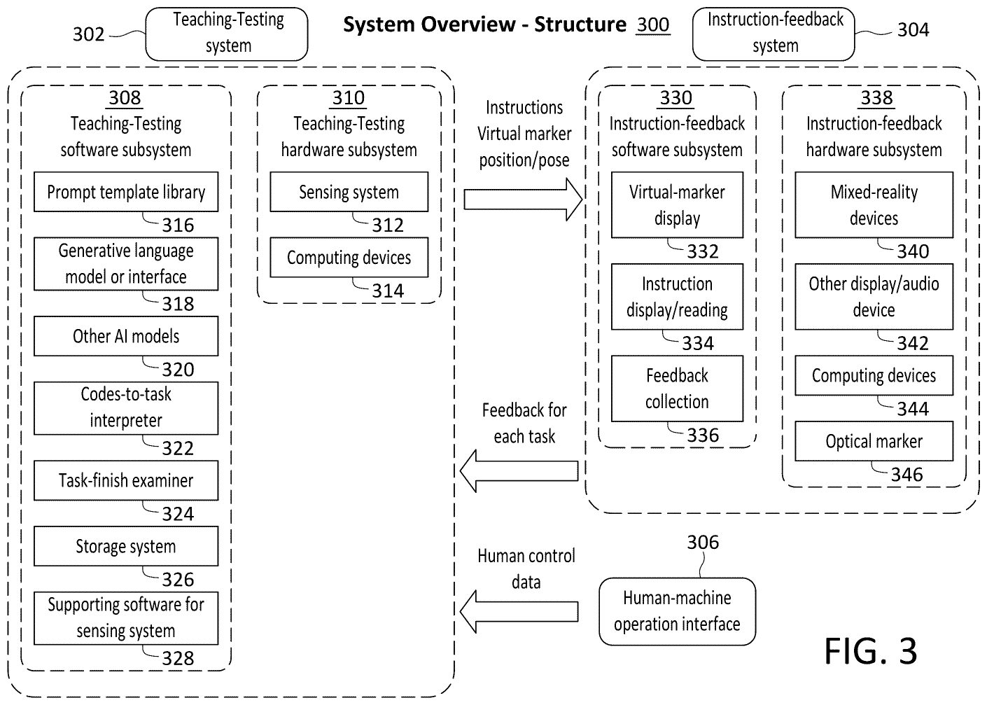

FIG. 3 illustrates the structure of a system 300 that implements the human-in-the-loop method of the current disclosure. System 300 may include three major components: a teaching-testing system 302, an instruction-feedback system 304, and a human-machine operation interface 306.

The teaching-testing system 302 may comprise a software subsystem 308 and a hardware subsystem 310. The hardware subsystem 310 may comprise a sensing system 312 and computing devices 314. The sensing system 312 may comprise a variety of different types of cameras and optical markers, such as RGB cameras, IR cameras, depth cameras, QR markers, and Aruco markers, motion capture systems, like Optitrack, as well as other types of sensors.

The computing devices 314 may host computation tasks, such as AI model inference, computer vision algorithms, capturing and processing audio signals, running the codes-to-task interpreter and the task-finish examiner, and running supporting software like Optitrack software. The computing devices 314 may comprise one or more processors and related systems, such as desktops, laptops, wearable computing devices (e.g., in a backpack), and the computing devices inside MR devices 340.

The software subsystem 308 may comprise the following components: a task-prompt template library 316, generative AI models or interfaces 318, other generative AI models 320, a codes-to-task interpreter 322, a task-finish examiner 324, a storage system 326, and supporting software 328 for the sensing system in the hardware subsystem. The elements of the software subsystem 308 and the hardware subsystem 310 will be described in more detail to follow. It will be noted that the codes-to-task interpreter 322 is also able to receive additional input besides computer code and interpret this input into human-operated robot tasks as will be explained in more detail to follow.

The system 300 includes the instruction-feedback system 304. The instruction-feedback system 304 may comprise an instruction-feedback software subsystem 330. The software subsystem 330 may comprise a virtual-marker display 332, an instruction display 334, and a feedback collection 336. System 300 may comprise an instruction-feedback hardware system 338. The instruction-feedback hardware system 338 may comprise MR devices 340, other display/audio devices 342, computing devices 344, and optical markers 346. An MR device 340 according to the described embodiments may comprise a virtual reality/augmented reality (VR/AR) device or other human-usable interface for providing a mixed reality view to a human, e.g., mixed reality glasses. In embodiments, the MR device 340 may comprise a platform that a human data collector can use to communicate with other elements of the system 300. The MR device 340 may comprise a bidirectional interface.

The system 300 may comprise a human-machine operation interface 306. In some embodiments, a human-machine operation interface 306 may comprise a forearm-mounted human-machine operation interface that is used to operate one or more robotic grippers or hands in the execution of complex grasping and manipulation tasks. The forearm-mounted human-machine operation interface may comprise a forearm stabilizer platform that attaches to a human data collector's forearm. A gripper support arm may comprise a first end coupled to an end of the forearm stabilizer platform. A gripper coupling member may be coupled to a second end of the gripper support arm. The gripper coupling member may couple the one or more robotic grippers or hands to the forearm-mounted human-machine operation interface so that the data collector can operate the one or more robotic grippers or hands with ease.

A grip handle may be connected to the gripper support arm to provide extra support. The grip handle may accommodate at least one input interface that receives user input and provides appropriate control commands to a microcontroller unit to control the operation of the one or more robotic grippers or hands. The forearm-mounted human-machine operation interface and/or the one or more robotic grippers and hands may comprise various sensors and control signals that are used for data collection. The collected data may be provided to a wearable computation subsystem for recording.

In some embodiments, the human-machine operation interface 306 may comprise a palm-mounted human-machine operation interface that is used to operate one or more robotic grippers or hands in the execution of complex grasping and manipulation tasks. A palm-mounted human-machine operation interface may comprise an interface body and a palm support coupled with the interface body. A gripper coupling member may be coupled to the interface body. The gripper coupling member may connect the one or more robotic grippers or hands to the palm mounted human-machine operation interface so that the data collector can operate the one or more robotic grippers or hands.

The palm-mounted human-machine operation interface may comprise at least one input interface that receives user input and provides appropriate control commands to a microcontroller unit to control the operation of one or more robotic grippers or hands. The palm-mounted human-machine operation interface and/or the one or more robotic grippers and hands may comprise various sensors and control signals that are used for data collection. The collected data may be provided to the wearable computation subsystem for recording.

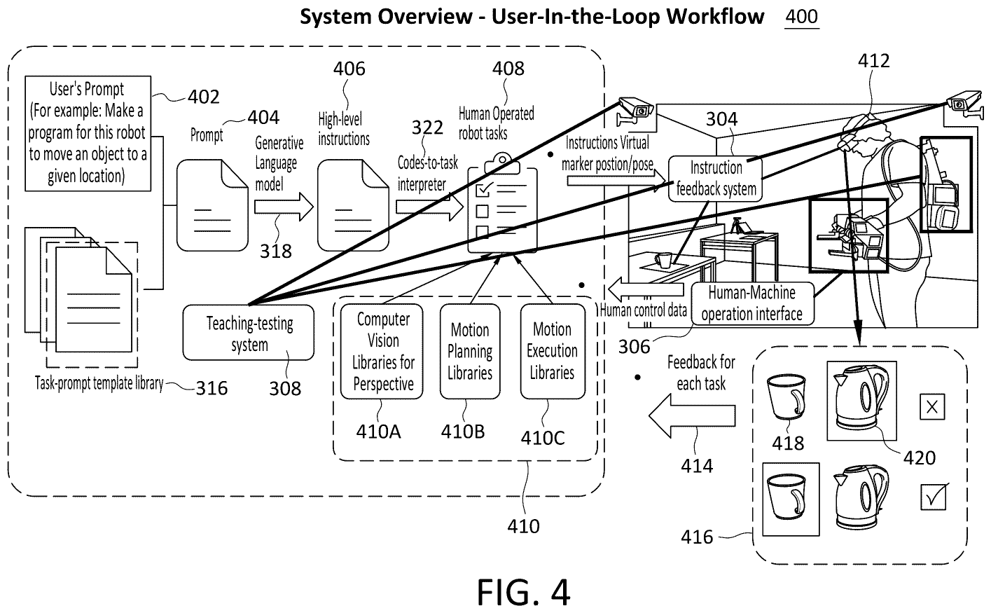

FIG. 4 shows a workflow 400 of an embodiment of a human-in-the-loop method that uses the system discussed in relation to FIG. 3. In the illustrated workflow, a user's prompt 402 is combined with a pre-defined task-prompt template library 316 to generate an appropriate prompt 404 to feed into a generative AI model 318. The generative AI model 318 creates high-level instructions 406, which may be, but are not limited to, Python codes, in the manner previously described in relation to FIG. 1.

In some embodiments, generating an appropriate prompt may include the creation of a state and environment description, e.g., using computer vision models. The state and environment description may specify constraints or requirements that are relevant to a robot task corresponding to the prompt, describe the environment in which the robot task is to take place, and/or describe the current state of the robot or robotic system. For example, the state and environment description may specify the weight, size, and shape of objects to be moved, may describe a size and a shape of an area relevant to the robot task as well as any obstacles or hazards that need to be avoided, and/or may describe the current position and orientation of relevant objects and the robot or robotic system.

Instead of deploying the high-level instructions onto a target robot, a human-in-the-loop method according to the current disclosure converts the high-level instructions 406 into human-operated robot tasks 408 with the codes-to-task interpreter 322. In various embodiments disclosed herein, the human-operated robot tasks may be considered instructions for the human data collector that operates the robot. Thus, the human data collector may receive the instructions and then operate the robot or at least a portion of the robot, such as the robot grippers, using the human-machine interface 306. Accordingly, the tasks are human-operated robot tasks.

In some embodiments disclosed herein, a human-operated robot task may be considered as a practice of a simple skill, like grasping an object or moving to a given location. A robot mission based on a user prompt can be split into multiple steps where each step can be translated into a human-operated robot task to be deployed on the instruction-feedback system 304.

A human data collector 412 equipped with the teaching-testing system 308 may follow the instructions shown in the proposed instruction-feedback system 304 to implement tasks with the human-machine interface 306 one by one. Some of the instructions may be generated by the low-level libraries 410, such as, but not limited to, computer vision libraries 410A, motion planning libraries 410B, and motion execution libraries 410C in the system, which may provide instructions with a single suggestion or with multiple choices.

For example, if the task is to pick up a cup from a table and there are several cups, the instructions may indicate multiple cups and the human data collector 412 may pick up the most appropriate one according to the context and goal of the task. In another example, the motion planning library 410B may suggest multiple poses to grasp an object, and the human data collector 412 may select one to use and score this suggested pose as feedback 414 using the instruction-feedback system 304. The human data collector 412 may also overwrite a wrong suggestion if he/she thinks it is necessary to use the instruction-feedback system 304.

A specific example 416 of using the instruction-feedback system 304 will be described. Suppose a task shown on the human executable tasks is to pick up a cup 418 from a table. However, as shown at 416, the computer vision library 410A in the system indicates a kettle 418 by incorrectly showing a virtual-marker display 332 on the kettle 420 in the MR device 340. In such a case, the human data collector 412 will know that a kettle is not a cup and may overwrite the task and leave feedback 414 like “This is a kettle, not a cup”. All the data of human demonstration and feedback may be recorded and processed to generate new datasets for future AI model retraining and/or for improving the task-prompt template library and/or for improving the low-level libraries, such as computer vision libraries, motion planning libraries, motion execution libraries, etc. Thus, with the collected dataset, the system can be re-trained to correctly recognize the cup and to show a virtual-marker display 332 on the cup 418 in the MR device 340.

A human-in-the-loop method may be implemented in two modes. A first mode may be a testing mode. In a testing mode, the human data collector 412 may be provided with a full list of human-operated robot tasks 408 that he/she is able to perform. For each task, the instruction-feedback system 304 may provide detailed instructions by text, voice, or virtual markers. For example, if a task is to walk close to a cup, the text or voice instructions may be displayed in MR devices indicating that the human data collector needs to walk close to a table. A virtual marker of a corresponding path and destination markers may be shown to the human data collector in the MR device. In another example, a task may be to pick up a cup, and markers of multiple possible grasping poses may be shown in the MR device.

A second mode may comprise a training mode. In the second mode, the instruction-feedback system 304 may provide no instructions or completely wrong instructions for some tasks and the human data collector 412 may switch to a teaching mode for determining how to perform those tasks. All the data in the teaching mode will recorded by the teaching-testing system 302. The data can be used to train the system on those tasks and/or to improve the task-prompt template library and/or to improve the low-level libraries, such as computer vision libraries, motion planning libraries, motion execution libraries, etc., based on the human data collector's feedback, such as the human data collectors actions in performing the tasks. In this way, real-time training can be achieved.

Although the above example was described using the human-machine interface 306, the use of the human-machine interface 306 is not required for all embodiments. For example, in one embodiment the data may be collected directly from the hands of the human data collector 412. In some embodiments, a depth camera or other camera of the sensing system 312, e.g., that is AI-equipped, may track the pose (i.e., the 3D orientation of the human data collector's hands) and/or movement of the human data collector's hands as the human data collector 412 performs the human-operated robot tasks. The collected data or feedback may then be provided to the wearable computation subsystem for recording. In various embodiments, an additional step may be added to workflow 400 of having the teaching-testing system 302 map the human-hand poses to poses that correspond to poses of robotic hands or grippers.

In some embodiments, the sensing system 312 may include motion detector sensors. For example, the human data collector 412 can place markers on his or her arms, hands, fingers, or joints of the fingers or hands. Motion detector sensors may then use the markers to track the pose and/or movement of the human data collector's hands as the human data collector 412 performs the human-operated robot tasks. The collected data or feedback may then be provided to the wearable computation subsystem for recording. In some embodiments, an additional step may be added to workflow 400 of having the teaching-testing system 302 map the human-hand poses to poses that correspond to poses of robotic hands or grippers.

In some embodiments, the human data collector 412 may wear an intelligent glove having various sensors embedded in the glove, such as is used in some gaming system gloves. The embedded sensors may track the pose and/or movement of the human data collector's hands as the human data collector 412 performs the human-operated robot tasks. The collected data may then be provided to the wearable computation subsystem for recording. In some embodiments, an additional step may be added to workflow 400 of having the teaching-testing system 302 map the human-hand poses to poses that correspond to poses of robotic hands or grippers.

In the example workflow 400, the high-level instruction 406 is not deployed onto any robot directly. Accordingly, the high-level instruction 406 can be a program in any programming language or description in any natural language. Further, as some novel human-operated robot tasks may not be fully described by existing functions of a programming language, the data collection may rely on human demonstration only. In such embodiments, natural language descriptions may be generated instead of codes in programming languages.

Thus, in some embodiments, the codes-to-task interpreter 322 need not only convert the high-level instruction to the list of human-operated robot tasks 408. Rather, in some embodiments the codes-to-task interpreter 322 can interpret the output of the generative AI model 318 and then generate the list of human-operated robot tasks 408 that can be executed by the human data collector 412 directly in a natural language format and/or visual/vocal instructions that are understandable by the human data collector 412. Thus, the codes-to-task interpreter 322 is a high-level interpreter that is able to take any input related to robot control and then generate the list of human-operated robot tasks 408 in any format that is understandable by the human data collector 412. Returning to FIG. 2, FIG. 2 illustrates applying the human-in-the-loop method to a real-world robotics application. In each application, the prompt 404 may be fed to the generative AI model 318 to generate high-level instructions or control codes 406 that are converted into human-operated robot tasks 408 with the codes-to-task interpreter 322. In application 212, the human data collector 412 is able to perform all three steps as evidenced by the check-mark 213.

However, in application 214, the human data collector 412 is not able to perform step 2 as evidenced by “X” 215 since this step failed. As shown at 216, the human data collector 412 is able to determine the failure of step 2. For example, if the step was to pick up a cup, but a kettle was marked for picking up. As shown at 217, the human data collector 412 corrects the failure of step 2 and all the tasks are able to be performed. The further steps the human data collector 412 took to correct the failure of step 2 are collected to be used for future training as described.

In application 218, the human data collector 412 is not able to perform steps 2 or 3 as evidenced by “X” 219 since both of these steps failed. As shown at 220, the human data collector 412 corrects the failure of step 2 and the failure of step 3 and all the tasks are able to be performed. The further steps the human data collector 412 took to correct the failure of step 2 and step 3 are collected to be used for future training as described. It will be appreciated if the human data collector 412 is able to correct the failures of steps 2 and 3 in one execution round, which is different from the user-on-the-loop method, where only one failure may be corrected at a time or for a given test run.

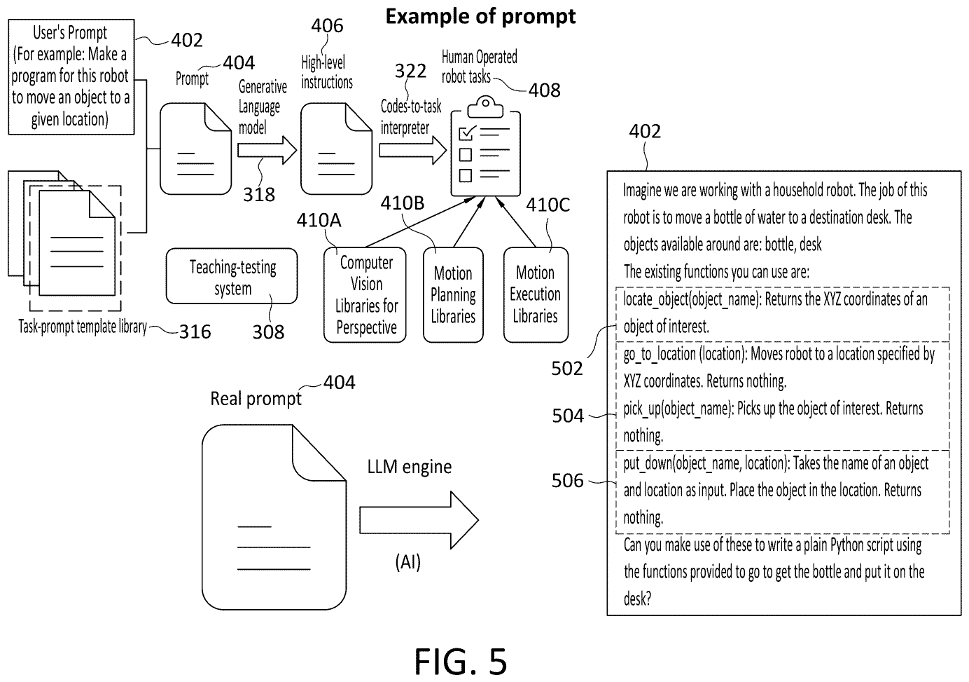

FIG. 5 shows an example of a generated prompt 404. The generated prompt may include the name, interface, and description of available high-level functions, the task description, the object/location names, and the prompt to generate codes. For example, FIG. 5 shows an example of the user's prompt that may be generated by the human user. Example task-prompt templates 502, 504, and 506 (shown in the boxes in the figure) describe available functions that can be used to generate the high-level instructions or control codes.

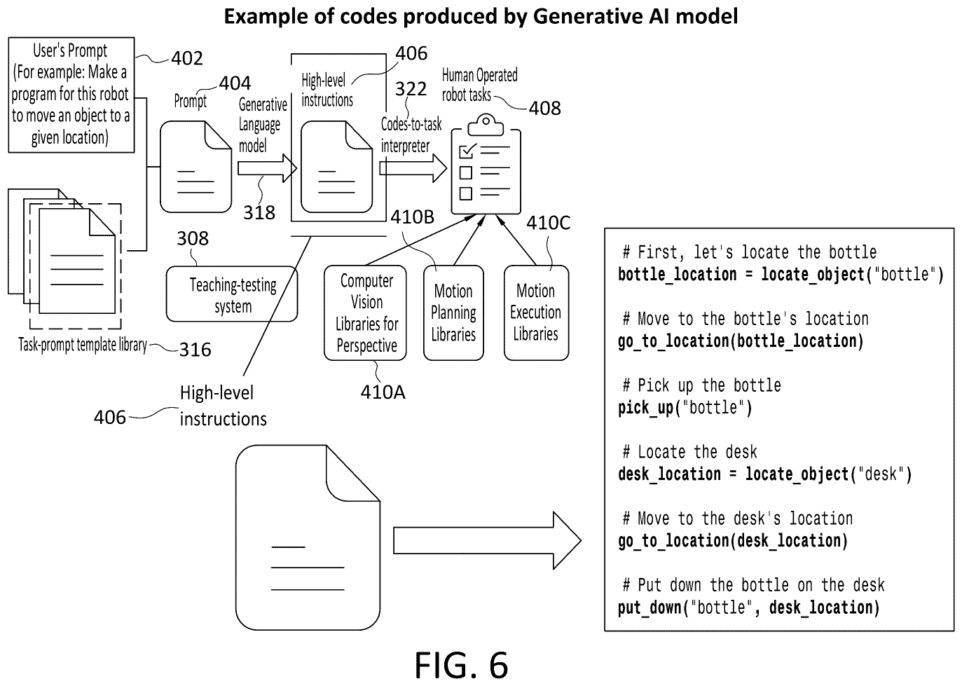

The generative AI models may take the generated prompts and create corresponding high-level instructions. FIG. 6 shows an example of high-level instructions 406 generated from a LLM for a given task. In some embodiments, the generative AI models may be hosted locally in the computing devices of the system, while in other embodiments the generative AI models may be hosted in cloud computing facilities and the corresponding interface, or application programming interface (API), can be called in the teaching-testing system to invoke the executions of the models on the generated prompts. Other AI models refer to AI models other than the AI model used to generate high-level instructions or control codes. Other generative AI models may include image-to-text generation models, video-to-text generation models, motion planning generation models, grasp pose generation models, and reinforcement learning models for motion execution.

The codes-to-task interpreter 322 is a component of the teaching-testing system 308, which converts the high-level instructions 406 into the list of human-operated robot tasks 408 that can be executed by human data collectors. Each human-operated robot task has a list of inputs, a list of outputs, a task description, and criteria of accomplishment, such as checking the finish or scoring a completion of the task. The inputs could be an indicator of an object, e.g., “bottle,” “cup,” or “desk.”

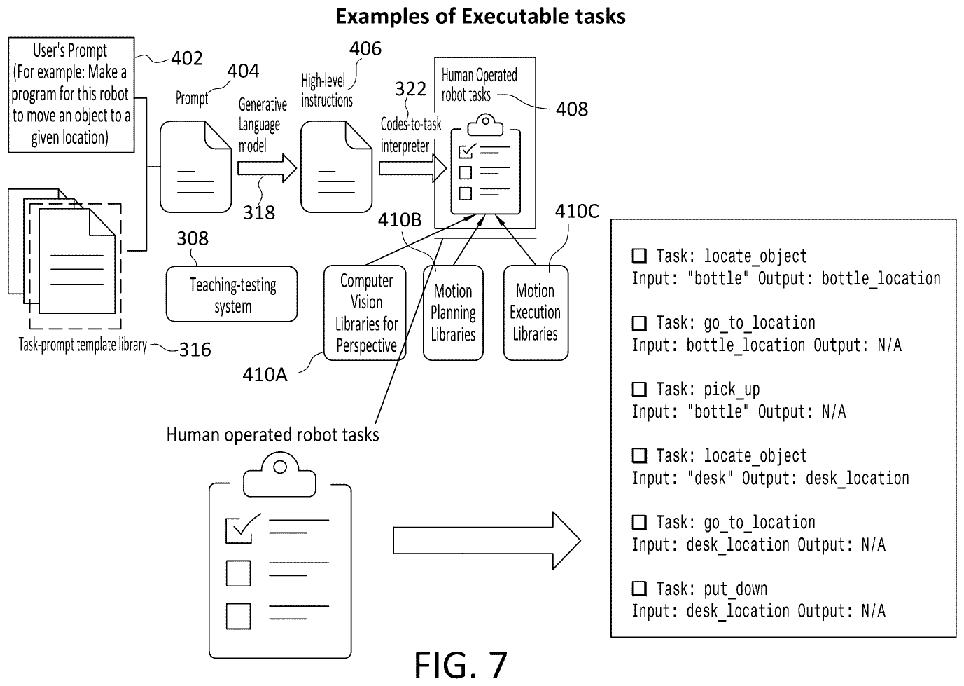

FIG. 7 shows an example of human-operated robot tasks for a given application. For each task, the list of inputs, the list of outputs, and the task description are shown. The criteria of accomplishment may not be easily described in text but may display in MR devices with virtual markers, and diagrams. Virtual markers and audio instructions may be generated for each task and sent to the instruction-feedback system.

The task-finish examiner 324 is a set of algorithms that check if the task is finished or how well the task is finished. It may connect to the sensing system to get the position/pose information of the objects of interest or connect to the MR devices 340 to get the position/pose information of the human data collector.

The storage system 326 may store all sensing data from the sensing system, human control data from the human-machine operation interface, and the feedback from the instruction feedback system.

The instruction-feedback system 304 may be configured for displaying virtual markers, and text instructions for tasks, collecting demonstrations from human data collectors, and collecting speech feedback from human data collectors. The hardware subsystem may comprise mixed-reality devices, other display, and audio devices, such as monitors, speakers, and microphones, computing devices running MR programs, and optical markers, like QR markers, for localization.

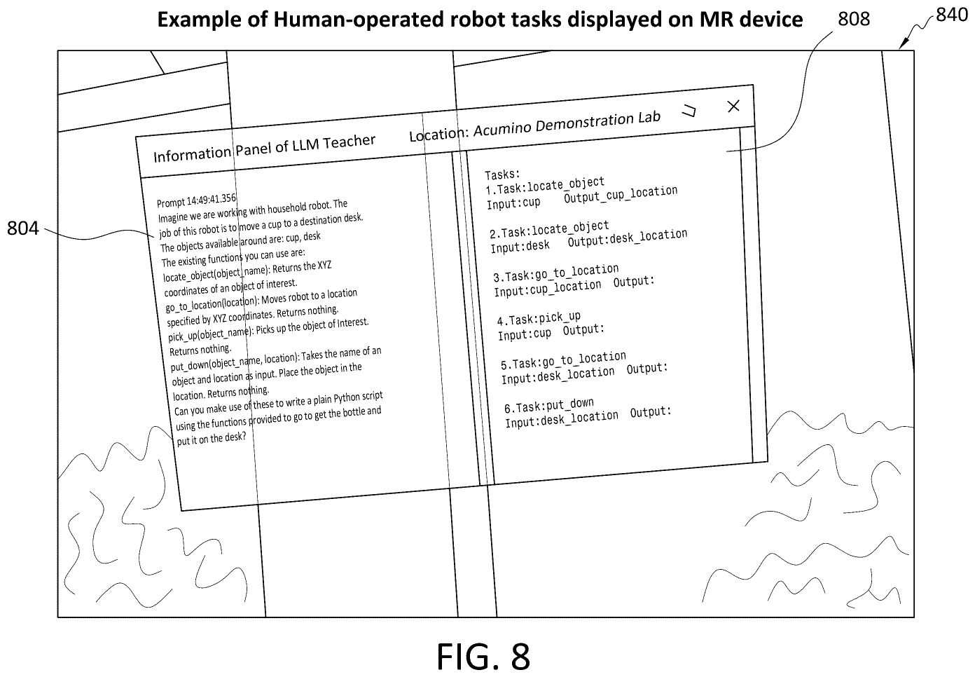

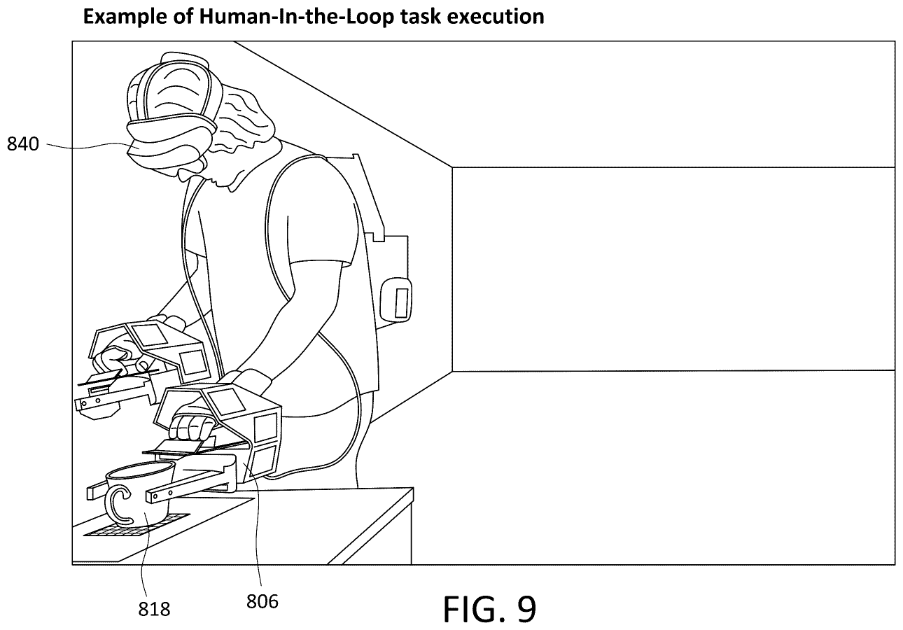

FIG. 9 illustrates an embodiment of a human data collector 412 performing the human-in-the-loop method. FIG. 9 shows the human data collector 412 wearing a human-machine operation interface 306 and an MR device 340, where the prompt 804 and a list of human-operated robot tasks 808 may be shown in the MR device 840 as illustrated in the view from FIG. 8. In the illustrated embodiment, the human-machine operation interface 806 is being used to pick up a cup 818 to be moved to another location.

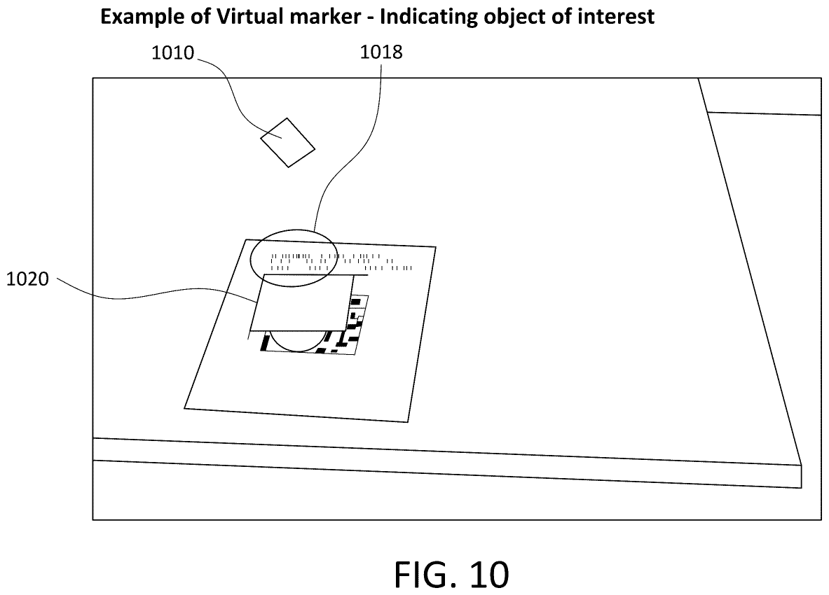

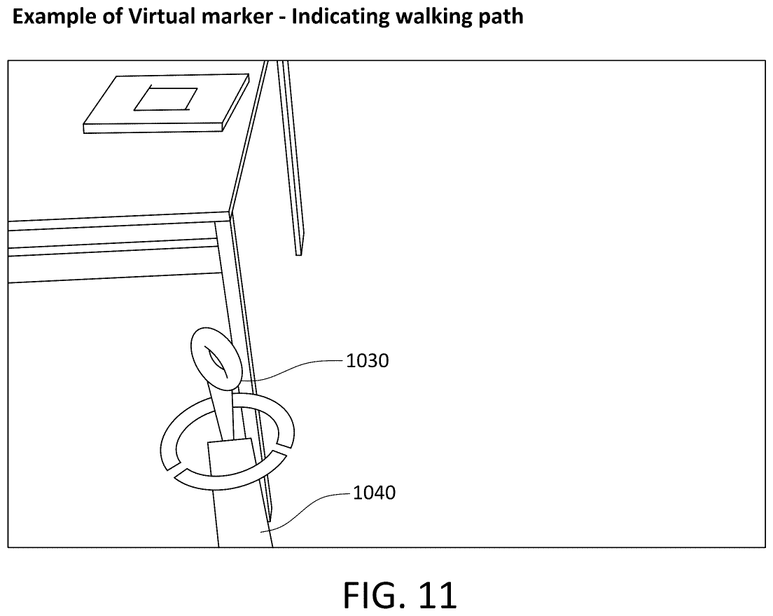

There are several software components in the instruction-feedback system: (1) Virtual-marker display, display virtual markers, like location indicator 1010, object indicator 1018, 1020, and paths to follow. FIG. 10 and FIG. 11 show an example of object indicators and location and path indicators 1030, 1040. (2) Instruction display/reading, which may be configured for displaying text information and playing audio instructions. FIG. 8 shows an example of human-operated robot tasks shown on an MR device 840. (3) Feedback collection, which collect human's verbal feedback and notes, as well as feedback from mixed-reality systems, such as gesture, gaze, and/or pointer feedback.

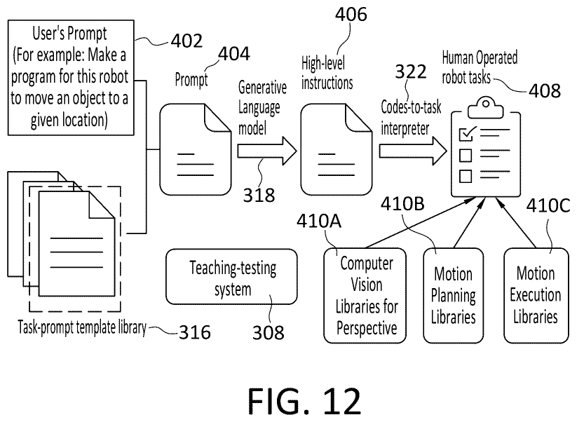

FIG. 12 illustrates a human-in-the-loop method to applying generative AI to robotics applications such as applications for deploying the robot to perform one or more tasks, for example using the system 300 according to FIG. 3. A human-in-the-loop method according to embodiments disclosed herein converts the high-level instructions into human-operated robot tasks and deploys them onto a teaching-testing system. A human data collector wears robotic devices and completes the tasks according to the instructions provided by the teaching-testing system. In failure cases, the human data collector knows which steps and which instructions cause the failure in real-time. As such, the human data collector can overwrite the wrong instructions, leave feedback or notes, and move forward without restarting the entire test or training.

The embodiments described herein provide a novel and non-obvious advantage over existing systems. For example, human-operated robot tasks are generated from high-level instructions of the AI models, such that a human data collector tests the human-operated robot tasks and can provide feedback for the AI models in real-time. Thus, rather than having to use an actual robot in multiple rounds of testing, which can be expensive and time-consuming, the human data collector tests the human-operated robot tasks and in so doing can identify failures in and improve future generation of high-level instructions provided by AI models. Further, as the human data collector directly tests the human-operated robot tasks rather than the tests being conducted virtually, the data that is collected is based on actual data and not merely virtual data, which can lead to better results.

Principles described herein may be performed in the context of a computing system, such that some introductory discussion of a computing system will be described for ease of understanding. Computing systems are now increasingly taking on a wide variety of forms. Computing systems may, for example, be hand-held devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

In its most basic configuration, a computing system typically includes at least one hardware processing unit and memory. The processing unit may include a general-purpose processor and may also include a field-programmable gate array (FPGA), an application-specific integrated circuit (ASIC), or any other specialized circuit. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system also has thereon multiple structures often referred to as an “executable component”. For instance, a memory of the computing system may include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, which are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent,” “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description above, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory of the computing system. A computing system may also contain communication channels that allow the computing system to communicate with other computing systems over, for example, a network.

While not all computing systems require a user interface, in some embodiments, a computing system may include a user interface system for use in interfacing with a user. A user interface system may include output mechanisms as well as input mechanisms. The principles described herein are not limited to precise output mechanisms or input mechanisms and, as such, will depend on the nature of the device. However, output mechanisms might include, for instance, speakers, displays, tactile output, holograms, and so forth. Examples of input mechanisms might include, for instance, microphones, touchscreens, holograms, cameras, keyboards, mouse or other pointer input, sensors of any type, and so forth.

Embodiments described herein may comprise or utilize a special purpose or general-purpose computing system, including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hard-wired, wireless, or a combination of hard-wired or wireless) to a computing system, the computing system properly views the connection as a transmission medium. Transmission media can include a network and/or data links that can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively, or in addition, the computer-executable instructions may configure the computing system to perform a certain function or group of functions. The computer-executable instructions may be, for example, binaries or even instructions that undergo some translation (such as compilation) before direct execution by the processors, such as intermediate format instructions such as assembly language or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computing systems, which are linked (either by hard-wired data links, wireless data links, or by a combination of hard-wired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The figures may discuss various computing systems which may include various components or functional blocks that may implement the various embodiments disclosed herein. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems of the remaining figures may include more or less than the components illustrated in the figures, and some of the components may be combined as circumstances warrant. Although not necessarily illustrated, the various components of the computing systems may access and/or utilize a processor and memory, as needed to perform their various functions.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for testing and/or improving a robot control system, the method comprising:
providing at a computation device a library of prompt templates that define one or more steps of one or more robot control tasks;
providing a prompt to one or more generative AI models, the one or more generative AI models generating high-level instructions, the high-level instructions configured to trigger, when executed, a robot to perform the one or more robot control tasks comprising one or more steps defined by the library of prompt templates;
converting the high-level instructions into human-operated robot tasks;
providing the human-operated robot tasks to a mixed reality device worn by a human data collector, the mixed reality device rendering the human-operated robot tasks in a manner that shows the human data collector how to perform the human-operated robot task;
receiving feedback data in response to the human data collector attempting to perform the human-operated robot tasks; and
updating the robot control system using the feedback data.

2. The method of claim 1, wherein the rendering of the human-operated robot tasks at the mixed reality device includes one or more of (1) input/output variables such as location of objects, (2) visual/voice instructions for display on the mixed reality device, and (3) checkable events or metrics as a result of tasks that can be examined/scored by the mixed reality device or by external sensors/systems.

3. The method of claim 1, further comprising generating the prompt from a combination of a prompt template from the library of prompt templates and a user prompt.

4. The method of claim 1, wherein the high-level instructions call predefined low-level libraries.

5. The method of claim 4, wherein the predefined low-level libraries include one or more of computer vision libraries, motion planning libraries, and motion execution libraries.

6. The method of claim 1, wherein the feedback data comprises an overwrite of one or more of the human-operated robot tasks by the human data collector.

7. The method of claim 1, wherein the feedback data comprises a score for one or more of the human-operated robot tasks provided by the human data collector.

8. The method of claim 1, wherein the human data collector performs the human-operated robot tasks using a human-machine interface.

9. The method of claim 8, wherein the human-machine interface comprises at least one input interface that receives user input and provides corresponding control commands to a microcontroller unit to control the operation of one or more robotic components.

10. The method of claim 9, wherein the one or more robotic components comprise one or more of a robotic gripper, a robotic limb, and a robotic wheel.

11. The method of claim 9, wherein the human-machine interface is a human-mounted human-machine interface.

12. The method of claim 1, wherein said updating the robot control system using the feedback data further comprises updating the one or more generative AI models using the feedback data.

13. A system for training and/or testing a robot control system, the system comprising:
a computation device configured to train and/or test the robot control system;
a data collection device configured to collect feedback data related to one or more human-operated robot tasks that are to be performed by a human data collector;
one or more sensing devices located in a location of the human data collector; and
a mixed reality device that is worn by the human data collector, the system configured to perform the following:
provide at the computation device a library of prompt templates that define one or more steps of one or more robot control tasks;
provide a prompt to one or more generative AI models, the one or more generative AI models generating high-level instructions, the high-level instructions configured to trigger, when executed, a robot to perform the one or more robot control tasks comprising said one or more steps defined by the library of prompt templates;
convert the high-level instructions into human-operated robot tasks;
provide the human-operated robot tasks to the mixed reality device worn by the human data collector, the mixed reality device rendering the human-operated robot tasks in a manner that shows the human data collector how to perform the human-operated robot task;
receive feedback data in response to the human data collector attempting to perform the human-operated robot tasks; and
update the robot control system using the feedback data.

14. The system of claim 1, wherein the rendering of the human-operated robot tasks at the mixed reality device includes one or more of (1) input/output variables such as location of objects, (2) visual/voice instructions for display on the mixed reality device, and (3) checkable events or metrics as a result of tasks that can be examined/scored by the mixed reality device or by external sensors/systems.

15. The system of claim 1, wherein the system is further configured for generating the prompt from a combination of a prompt template from the library of prompt templates and a user prompt.

16. The system of claim 1, wherein the high-level instructions call predefined low-level libraries, the predefined low-level libraries including one or more of computer vision libraries, motion planning libraries, and motion execution libraries.

17. The system of claim 1, wherein the feedback data comprises an overwrite of one or more of the human-operated robot tasks by the human data collector, and/or wherein the feedback data comprises a score for one or more of the human-operated robot tasks provided by the human data collector.

18. The system of claim 1, wherein said updating the robot control system using the feedback data further comprises updating the one or more generative AI models using the feedback data.

19. The system of claim 1, further comprising a human-machine interface configured to be operated by the human data collector in performing the human-operated robot tasks,
wherein the human-machine interface comprises at least one input interface that receives user input and provides corresponding control commands to a microcontroller unit to control operation of one or more robotic components.

20. The system of claim 19, wherein the one or more robotic components comprise one or more of a robotic gripper, a robotic limb, and a robotic wheel.
